(19) United States
(12) Patent Application Publication
(10) Pub. No.: US 2018/0209693 A1
(43) Pub. Date: Jul. 26, 2018

(54) Plastic Mounting Support For Solar Panels

(71) Applicant: BASF SE, Ludwigshafen (DE)

(72) Inventors: Matthew Parkinson, Bloomfield Hills, MI (US); Anil Kumar, Los Angeles, CA (US)

(21) Appl. No.: 15/322,761

(22) PCT Filed: Jun. 29, 2015
(86) PCT No.: PCT/US2015/038302

§ 371 Date: Dec. 29, 2016

Related U.S. Application Data
(60) Provisional application No. 62/020,647, filed on Jul. 3, 2014.

(51) Int. Cl. F24S 25/30; H02S 20/23

(52) U.S. Cl. CPC F24J 2/5237; H02S 20/23; F24J 2002/4692; F24J 2/5239; F24J 2/5205

(57) ABSTRACT

A plastic mounting support (10, 110, 210) for a solar panel (12) includes a plastic base (16, 116, 216) adapted to engage a support surface and support a ballast block (26) and a plastic member (24, 124, 224) for connection to the solar panel (12) and cooperating with the base (16, 116, 216) to hold the ballast block (26) therebetween such that the ballast block cooperates with the plastic mounting support (10, 110, 210) to carry part of a downward load on the solar panel (12), as well as, resists an upward wind load on the solar panel (12).

### CROSS-REFERENCE TO RELATED APPLICATIONS

The present application claims priority to and all the benefits of U.S. Provisional Patent Application No. 62/020,647, filed on Jul. 3, 2014, which is hereby expressly incorporated herein by reference in its entirety.

### BACKGROUND OF THE INVENTION

### 1. Field of the Invention

The present invention relates generally to mounting supports for solar panels and, more particularly, to a plastic mounting support for a solar panel on flat or low slope roof installations.

### 2. Description of the Related Art

It is known to provide a mounting support or mount for a solar panel. In at least one form, the mount has a bottom for placement on a flat surface and a plurality of walls extending upwardly from the bottom to form a box-shaped chamber for receiving ballast such as gravel or paving stones as “dead weight” to hold the mount in place against wind uplift, etc. The mount also has flanges extending outwardly from the walls to provide supporting surfaces for laying on the solar panel and fastening mechanisms for fastening the solar panel on the supporting surfaces. The mount is produced from a thermoset or thermoplastic material by an injection molding process or low pressure process. Recently, the solar industry has instituted aggressive cost targets for mounting supports in order to reduce overall solar installation costs to compete with other forms of energy. Designing a support or mount for a solar panel that meets the low cost target while meeting performance targets is a great challenge for the industry.

It is, therefore, desirable to provide a plastic mounting support for a solar panel that provides a cost efficient solution. It is also desirable to provide a plastic mounting support for a solar panel that uses existing blocks for ballast made of materials such as cement, sand, or gravel as a primary structure. It is further desirable to provide a plastic mounting support that cooperates with a ballast block that carries part of a load on the entire structure. It is still further desirable to provide a plastic mounting support that can be used for every location and configuration for mounting solar panels.

### SUMMARY OF THE INVENTION

Accordingly, the present invention is a plastic mounting support for a solar panel. The plastic mounting support includes a plastic base adapted to engage a support surface and support a ballast block and a plastic member for connection to the solar panel and cooperating with the base to hold the ballast block therebetween such that the ballast block cooperates with the plastic mounting support to carry part of a downward load on the solar panel, as well as, resists an upward wind load on the solar panel.

One advantage of the present invention is that a plastic mounting support is provided for mounting a solar panel thereon. Another advantage of the present invention is that the plastic mounting support meets load and structural requirements for a solar panel mounted thereon. Yet another advantage of the present invention is that the plastic mounting support incorporates existing one or more cement blocks as ballast for a primary structure to reduce the amount of plastic material for the support. Still another advantage of the present invention is that the plastic mounting support uses the cement blocks as a safety factor structural support if for some reason the plastic material experiences greater than designed for loads or the plastic material experiences creep or any type of mechanical overload. A further advantage of the present invention is that the plastic mounting support can withstand relatively large loads on the solar panel. Yet a further advantage of the present invention is that the plastic mounting support can be used for every location and configuration for mounting a solar panel. Still a further advantage of the present invention is that the plastic mounting support provides a cost efficient solution by being made of plastic and using existing cement blocks as ballast. Another advantage of the present invention is that the plastic mounting support weight is reduced compared to conventional solar mounts made with plastic materials.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a perspective view of one embodiment of a plastic mounting support, according to the present invention, illustrating a solar panel mounted thereon at an angular incline.

FIG. 1A is a view similar to FIG. 1 illustrating adjustment of an angle of the solar panel by the plastic mounting support.

FIG. 2 is perspective view of the plastic mounting support of FIGS. 1 and 1A illustrated with two ballast blocks.

FIG. 3 is view similar to FIG. 2 of the plastic mounting support without the ballast blocks.

FIG. 4 is another perspective view of the plastic mounting support of FIG. 3.

FIG. 5 is a side elevational view of another embodiment, according to the present invention, of the plastic mounting support of FIG. 1 illustrating a solar panel mounted thereon at a first angular incline.

FIG. 6 is a rear elevational view of the plastic mounting support and solar panel of FIG. 5.

FIG. 7 is a side elevational view of the plastic mounting support of FIG. 5 illustrating a solar panel mounted thereon at a second angular incline.

FIG. 8 is a rear elevational view of the plastic mounting support and solar panel of FIG. 5.

FIG. 9 is a fragmentary view of yet another embodiment, according to the present invention, of the plastic mounting support of FIG. 1 with a ballast block disposed therein.

FIG. 10 an exploded perspective view of the plastic mounting support of FIG. 9.

FIG. 11 is a perspective view of still another embodiment, according to the present invention, of the plastic mounting support of FIG. 3 without ballast blocks disposed therein.

FIG. 12 is a perspective view of a further embodiment, according to the present invention, of the plastic mounting support of FIG. 3 without ballast blocks disposed therein.

### DETAILED DESCRIPTION OF THE PREFERRED EMBODIMENT(S)

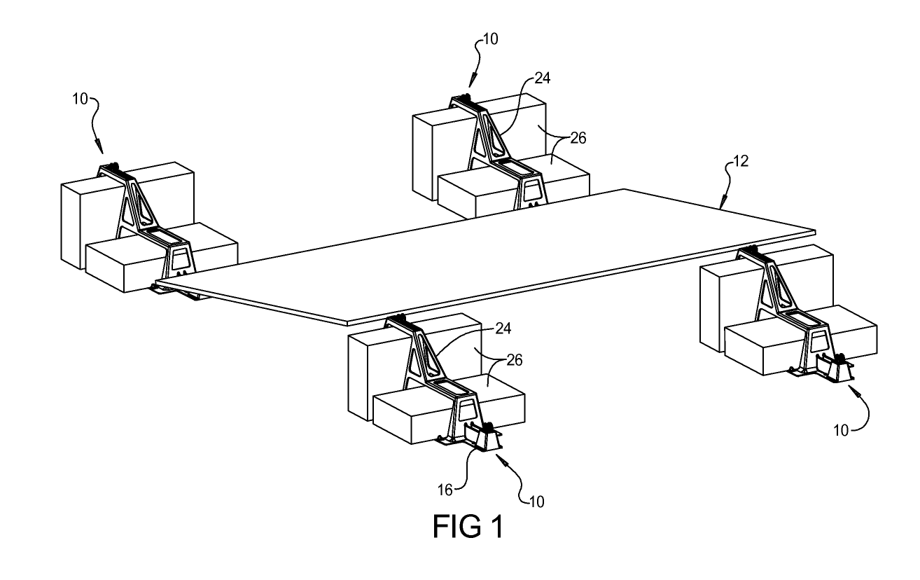

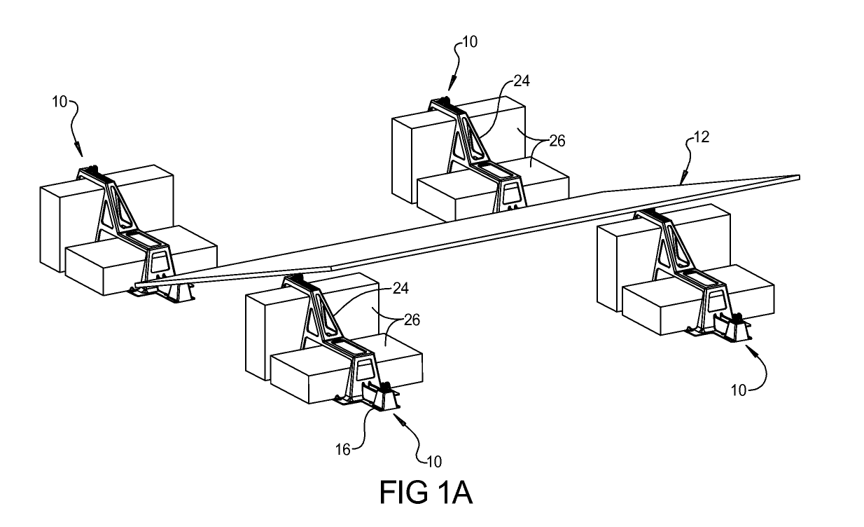

Referring to the figures, wherein like numerals indicate like parts throughout the several views, one embodiment of a plastic mounting support, according to the present invention, is shown generally at 10. The plastic mounting support 10 is configured to have a solar panel, generally indicated at 12, mounted thereon. As illustrated in FIG. 1, the solar panel 12 is generally rectangular in shape and has one plastic mounting support 10 near each corner for a total of (4). The solar panel 12 is secured to the plastic mounting supports 10 by suitable mechanism such as fasteners (not shown). It should be appreciated that the solar panel 12 illustrated in FIG. 1 is known in the art and is commercially available. It should also be appreciated that the solar panel 12 illustrated in FIG. 1 is not intended to limit the scope of the present invention. It should further be appreciated that the plastic mounting support 10 may be used with various other types of solar panels, not specifically shown herein, without departing from the scope of the present invention.

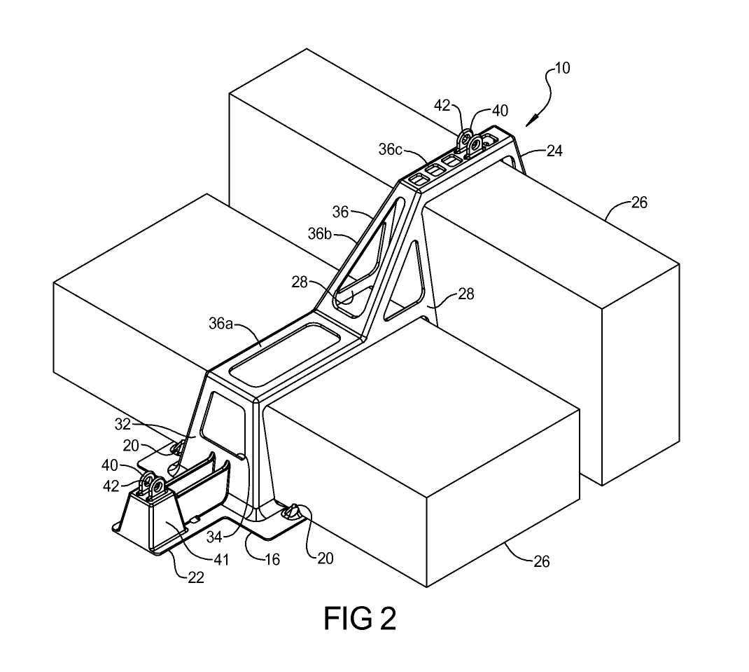

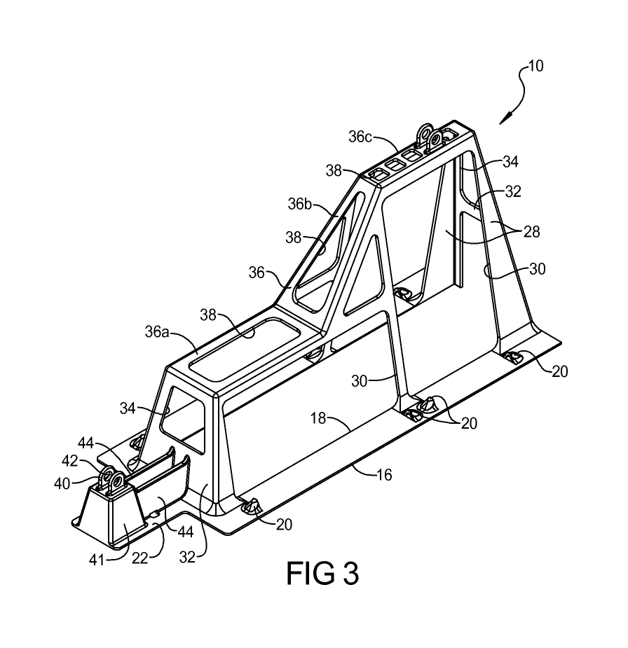

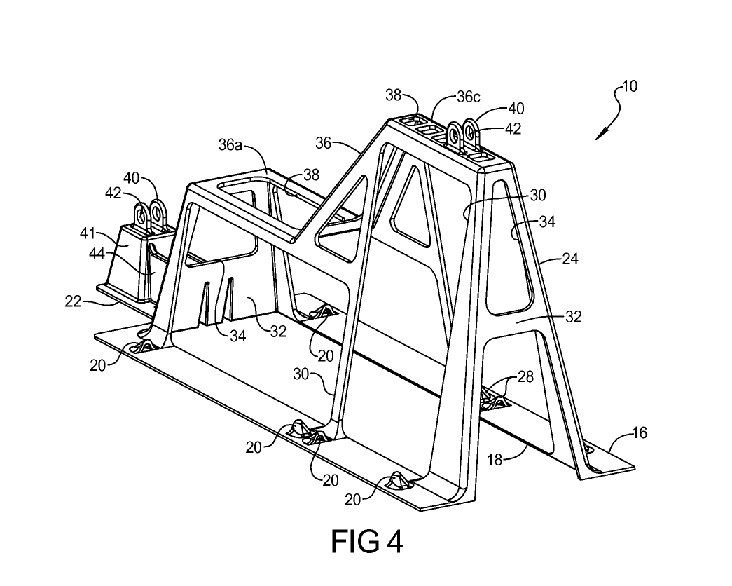

Referring to FIGS. 1 through 4, the plastic mounting support 10 includes a plastic base 16 for engaging a support surface such as a flat roof of a building. The base 16 is generally rectangular in shape, but may be any suitable shape. In one embodiment, the base 16 has a slot 18 formed axially therein to form a generally inverted “U” shape and planar member. The base 16 may include one or more stops 20 extending upwardly therefrom and spaced longitudinally from each other. The stops 20 project upwardly from the base 16 and have one side that is relatively planar to engage a ballast block 26 to be described to hold down the base 16 to the support surface. The base 16 may also have a mounting flange 22 extending longitudinally from a closed end thereof. The mounting flange 22 has a width less than a width of the base 16. The base 16 is made of a plastic material. The base 16 is integral, unitary, and one-piece.

The plastic mounting support 10 also includes a plastic member 24 adapted to extend over one or more ballast blocks 26 for connection to the solar panel 12 and cooperating with the base 16 to hold the ballast blocks 26 therein. In the embodiment illustrated in FIGS. 1 through 4, two ballast blocks 26 are used with one plastic mounting support 10. The ballast blocks 26 are generally rectangular in shape. In one embodiment, the ballast blocks 26 are made of cement. The ballast blocks 26 have a size of typically 4 inches by 8 inches by 16 inches. It should be appreciated that other suitable sized ballast blocks 26 may be used. It should also be appreciated that the ballast blocks 26 may be made of other suitable material such as sand, gravel, etc.

As illustrated in FIGS. 1 through 4, the member 24 includes a pair of side walls 28 extending longitudinally and upwardly from opposed longitudinal sides of the base 16. In one embodiment, the side walls 28 extend upwardly at an angle. Each of the side walls 28 includes one or more apertures 30 extending laterally therethrough to allow the ballast blocks 26 to extend through the side walls 28. The apertures 30 are generally rectangular in shape, but may be any suitable shape to complement the ballast blocks 26. In one embodiment, one of the apertures 30 has a height greater than a height of the other aperture 30 and the one aperture 30 has a width greater than a width of the other aperture 30. The apertures 30 are greater in height and width of the ballast blocks 26 such that the ballast blocks 26 rest on the base 16 between the stops 20 and do not contact the member 24. It should be appreciated that a space or gap exists between the ballast blocks 26 and the member 24. It should also be appreciated that the side walls 28 may include other apertures to reduce weight and material.

The member 24 also includes a pair of end walls 32 extending laterally between the side walls 28 and upwardly from opposed lateral ends of the base 16. In one embodiment, the end walls 32 extend upwardly at an angle. Each of the end walls 32 may include one or more apertures 34 extending therethrough to reduce weight and material. The apertures 34 are generally rectangular in shape, but may be any suitable shape. In one embodiment, one of the end walls 32 has a height greater than a height of the other end wall 32.

The member 24 further includes a top wall 36 extending longitudinally between the end walls 32 and laterally between the side walls 28. The top wall 36 is generally rectangular in shape, but may be any suitable shape. In the embodiment illustrated, the top wall 36 has a stair-step configuration of a first top wall 36a, a second top wall 36b, and a third top wall 36c. The third top wall 36c is at a height greater than the first top wall 36a. The top wall 36 may include one or more apertures 38 extending therethrough to reduce weight and material. It should be appreciated that the top wall 36 may have any suitable configuration.

The plastic mounting support 10 includes one or more projections 40 for attachment to the solar panel 12. In the embodiment illustrated, the member 24 has one projection 40 extending outwardly and upwardly from the top wall 36. The projection 40 has an aperture 42 extending therethrough to receive a fastening mechanism such as a fastener or rod (not shown) for connection to the solar panel 12. The projection 40 may a single piece or a pair of members spaced laterally from each other with each member having an aperture 42 extending therethrough. In the embodiment illustrated, the base 16 has one projection 40 extending outwardly and upwardly from a pedestal 41 extending upwardly from the mounting flange wall 22. The projection 40 has an aperture 42 extending therethrough to receive a fastening mechanism such as a fastener or rod (not shown) for connection to the solar panel 12. The projection 40 may a single piece or a pair of members spaced laterally from each other with each member having an aperture 42 extending therethrough. The base 16 may include one or more ribs 44 extending longitudinally between the projection 40 and the end wall 32. The ribs 44 may be spaced laterally. It should be appreciated that the plastic mount support 10 is modular and that a plurality of the mounting supports 10 may be stacked together for shipping.

The plastic mounting support 10 is made of a polymeric material. The polymeric material may be a thermoplastic or a thermoset. In one embodiment, the base 16 and member 24 are made of a polymeric material reinforced by a percentage of fibers by weight based on a total volume of the polymeric material. In one embodiment, the percentage of fibers ranges from zero percent (0%) to approximately sixty-five percent (65%). The fibers are at least one of a glass, carbon, mineral, and/or metallic material. In one embodiment, the fibers are typically long glass or carbon fibers, short glass or carbon fibers, or a combination of long and short glass and/or carbon fibers. It should be appreciated that the fibers may vary in size (e.g. length, diameter, etc.) and may be coated or uncoated. For example, in one embodiment, the fibers may have an average diameter of less than 13 microns. In other embodiments, the fibers may have an average diameter of 10 microns or less. The polymeric material or the fibers themselves may include other components to encourage bonding between the polymeric material itself and the fibers. An example of suitable fibers for the present invention includes ChopVantage® HP 3660 commercially available from PPG Industries Inc., One PPG Place, Pittsburgh, Pa. 15272.

The polymeric material could be any polymer, such as one of the following classes of thermoplastic or thermoset polymers: any member from the group of polyesters, polyamide, polyethylene, polyethylene terephthalate, acrylonitrile, butadiene styrene, polymethyl methacrylate, cellulose acetate, cyclic olefin copolymers, fluoropolymers, polyoxymethylene, polyacrylates, polyacrylonitrile, polyaryletherketone, polyamide-imide, polybutylene terephthalate, polyurethanes, polyketone, polyetheretherketone, polyetherimide, polycarbonate, polymethylpentene, polyphenylene sulfide, polyphenylene oxide, polyphthalamide, polystyrene, polysulfone, polyvinyl chloride, and styrene-acrylonitrile, and any combinations thereof.

In one embodiment, the polymeric material is a polyamide. Although not required, the polyamide is typically selected from the group of polyamide 6, polyamide 6,6, polyamide 46, polyamide 6,10, polyamide 6I,6T, polyamide 11, polyamide 12, polyamide 6,12, and any combinations thereof. However, it should be appreciated that polymeric materials other than polyamides may also be used to manufacture the plastic mounting support 10. An example of a suitable polyamide for the present invention includes Ultramid® 8233G HS commercially available from BASF Corporation, 100 Campus Drive, Florham Park, N.J. Another example of a suitable plastic material is Ultramid® B3WG10 commercially available from BASF Corporation, 100 Campus Drive, Florham Park, N.J.

In one embodiment, the polymeric material may include an impact modifier for imparting impact resistance to the polymeric material. When employed, the impact modifier is typically present in an amount of from about 1 to about 20 parts by weight based on a total weight of the polymeric material. The impact modifier could be any impact modifier, but may be selected from the group of elastomers, ethylene copolymers, ethylene-propylene copolymers, ethylene-propylene-diene terpolymers, ethylene-acrylate copolymers, styrene-butadiene copolymer, styrene-ethylene/butylene-styrene terpolymers, polyurethanes, and any combinations thereof. An example of a suitable impact modifier for the present invention is FUSABOND® grade N493D commercially available from DuPont Company, Lancaster Pike & Route 141, Wilmington, Del. 19805.

In another embodiment, the polymeric material may include ultra-violet (UV) stabilizers, for example, a benzotriazole-type ultraviolet absorber.

In yet another embodiment, the polymeric material may include pre-color pigments or dyes. Although not required, the polymeric material may comprise a colorant component for modifying a pigment or dye of the polymeric material. When employed, the colorant component is typically present in an amount such as 0.01 to about 10 parts by weight based on a total weight of the polymeric material. An example of a suitable colorant component for the present invention is Orient Nigrosine Base SAPL commercially available from Orient Corporation of America, 1700 Galloping Hill Road, Kenilworth, N.J. 07033. It should be appreciated that the other suitable impact modifiers, UV stabilizers, and pre-color pigments known in the art may be used.

In yet another embodiment, the polymeric material may include an additive to improve ignition resistance of the polymeric material, such as a phosphorus compound.

The present invention further provides a method of making the plastic mounting support 10. In one embodiment, the plastic mounting support 10 is made from an injection molding process. In another embodiment, the plastic mounting support 10 is made from a gas-assisted injection molding process.

The method generally includes the steps of providing a mold (not shown) which defines a cavity and core for the plastic mounting support 10. In one embodiment, the method includes the steps of injecting polymeric material into the cavity and core of the mold to form the plastic mounting support 10 at a predetermined height to attach the solar panel 12 at a specific angle. In another embodiment, cavity and core inserts (not shown) are inserted into the mold prior to the step of injecting the polymeric material to form the pedestal 41 and the plastic mounting support 10 to allow the solar panel attachment height of the support 10 to be raised or lowered to decrease or increase, respectively, the angle of the solar panel 12. Once the plastic mounting support 10 is formed, the method further includes the steps of opening the mold and removing the plastic mounting support 10 from the mold. It should be appreciated that the injected molded plastic mounting support 10 is one-piece. It should be appreciated that plastic mounting support 10 may be made by various other methods, not specifically described herein.

In operation, one plastic mounting support 10 is disposed near one corner of the solar panel 12 as illustrated in FIG. 1. One ballast block 26 is disposed on the base 16 and extended through one aperture 30 in the side wall 28 of the member 24. The solar panel 12 is fastened to the projection 40. The plastic mounting supports 10 may be moved relative toward and away each other to mount or adjust the solar panel 12 at a predetermined angle of inclination such as zero (0) degrees to approximately thirty (30) degrees, thereby allowing optimal solar radiation exposure to the solar panel 12 and maximum energy generation efficiency as illustrated in FIG. 1A. It should be appreciated that the ballast blocks 26 act as a weight to secure and hold the plastic mounting support 10 to the support surface and resist movement if wind engages the solar panel 12. It should also be appreciated that the ballast blocks 26 provides secondary support to prevent failure of the mounting support 10 because the solar panel 12 may be subjected to downward loading by snow and/or a significant upward load or uplift force by wind. It should further be appreciated that, when the plastic mounting support 10 is loaded for a long period of service life, mechanical creep can occur and the ballast block 26 provides secondary support. It should still further be appreciated that the plastic mounting support 10 may include a sliding track (not shown) and/or power drive (not shown) to automatically adjust the angle of the solar panel 12 relative to the angle of the sun.

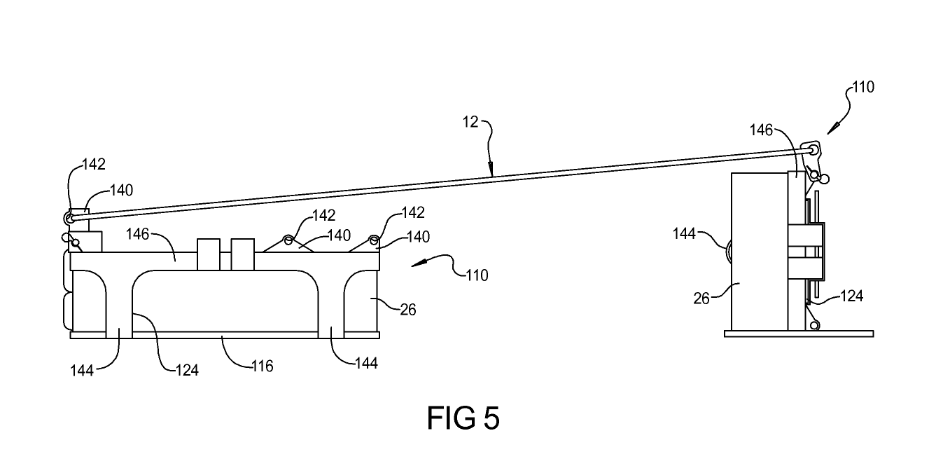

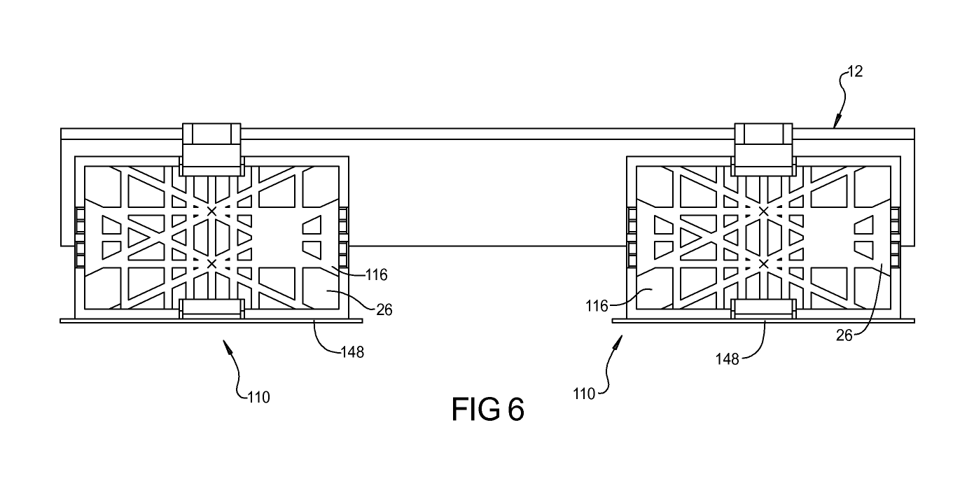

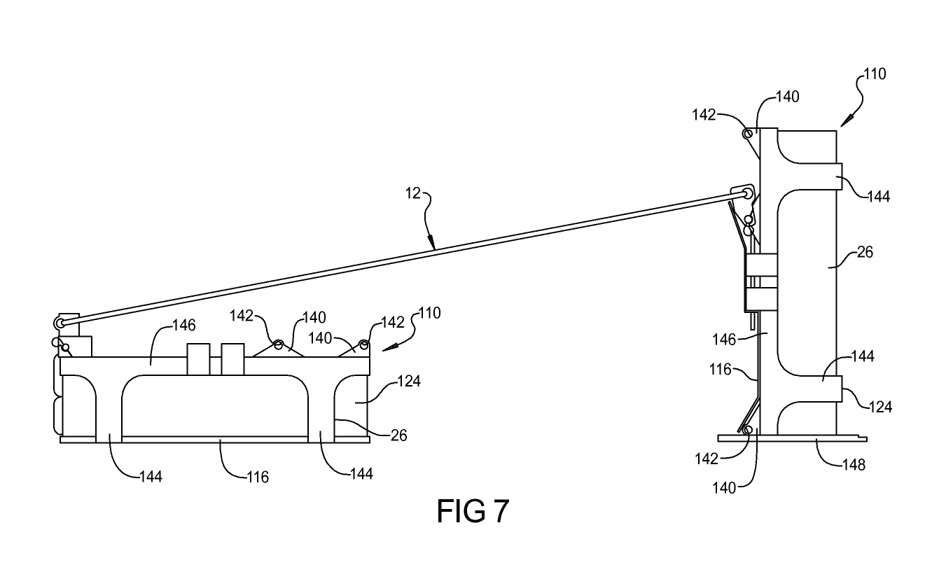

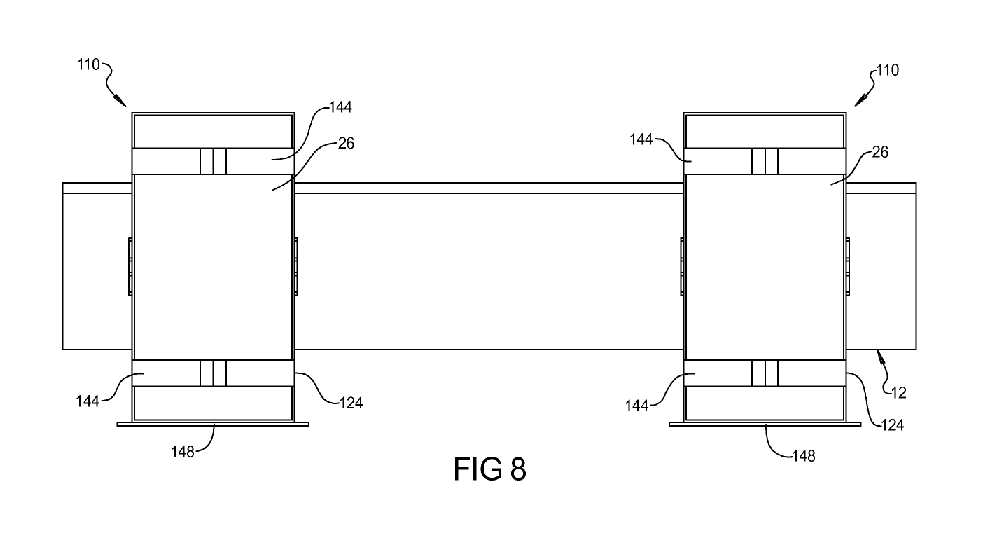

Referring to FIGS. 5 through 8, another embodiment, according to the present invention, of the plastic mounting support 10 is shown. Like parts of the plastic mounting support 10 have like reference numerals increased by one hundred (100). In this embodiment, the plastic mounting support 110 includes the base 116 and the member 124 extending from the base 116. The base 116 is generally planar and rectangular in shape. The member 124 includes one or more side members 144 extending upwardly from the base 116 and over a side of the ballast block 26 opposite the side contacting the base 116. The member 124 also includes a top member 146 extending longitudinally between the side members 144. The member 124 includes at least one projection 140 extending upwardly from the top member 146 and having an aperture 142 extending therethrough for attachment to the solar panel 12. The plastic mounting support 110 may include an end wall 148 extending generally perpendicular to the base 116. It should be appreciated that the plastic mounting support 110 is made of a plastic material and is integral, unitary, and one-piece. It should also be appreciated that the same mounting support 110 is used for every location and configuration.

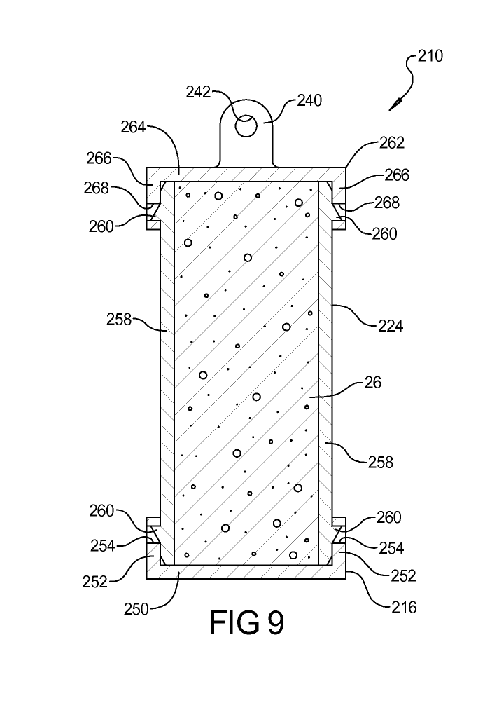

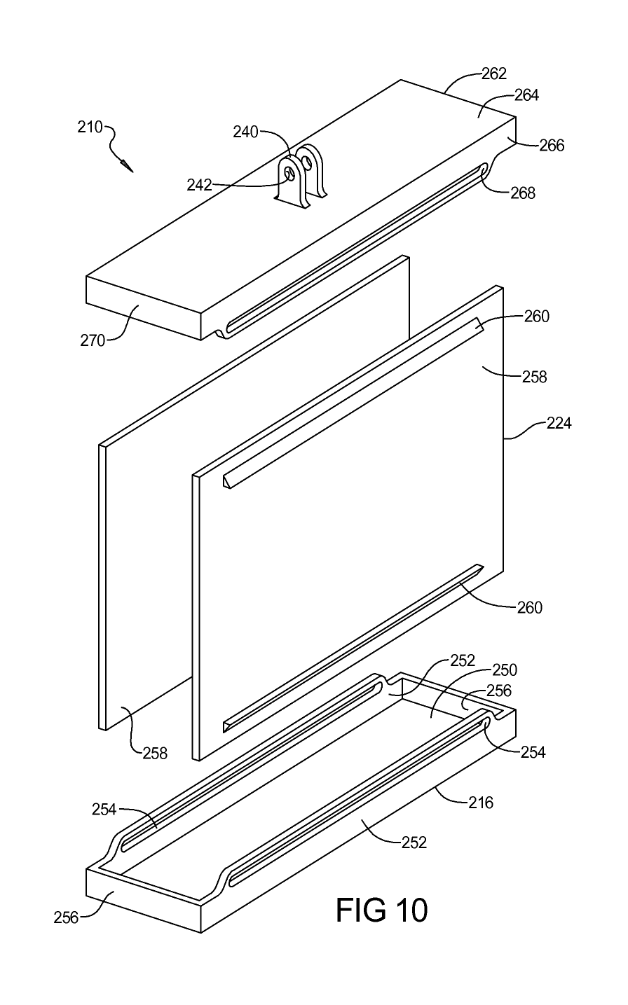

Referring to FIGS. 9 and 10, yet another embodiment, according to the present invention, of the plastic mounting support 10 is shown. Like parts of the plastic mounting support 10 have like reference numerals increased by two hundred (200). In this embodiment, the plastic mounting support 210 includes the base 216 and the member 224 extending from the base 216. The base 216 has a bottom wall 260 and opposed side walls 252 extending upwardly from the bottom wall 250. Each of the side walls 252 has an aperture 254 extending therethrough. The base 216 also has end walls 256 extending between the side walls 252 and upwardly from the bottom wall 250.

The member 214 includes a pair of opposed straps 258. The straps 258 are generally rectangular in shape. The straps 258 may include upper and lower projections 260 extending outwardly for cooperating with one of the apertures 254 in one of the side walls 252. It should be appreciated that a width of the straps 258 may be varied.

The member 214 includes a cap 262 disposed on the ballast block 26 opposite the base 216. The cap 262 has a top wall 264 and opposed side walls 266 extending downwardly from the top wall 264. Each of the side walls 266 have an aperture 268 extending therethrough. The cap 262 also has end walls 270 extending between the side walls 266 and downwardly from the top wall 264. The member 224 includes at least one projection 240 extending upwardly from the top wall 264 of the cap 262 and having an aperture 242 extending therethrough for attachment to the solar panel 12. It should be appreciated that the upper projection 260 on the strap 258 is received in one of the apertures 268 in one of the side walls 266. It should also be appreciated that the plastic mounting support 210 is made of a plastic material and each piece or member is integral, unitary, and one-piece. It should further be appreciated that the same mounting support 210 is used for every location and configuration.

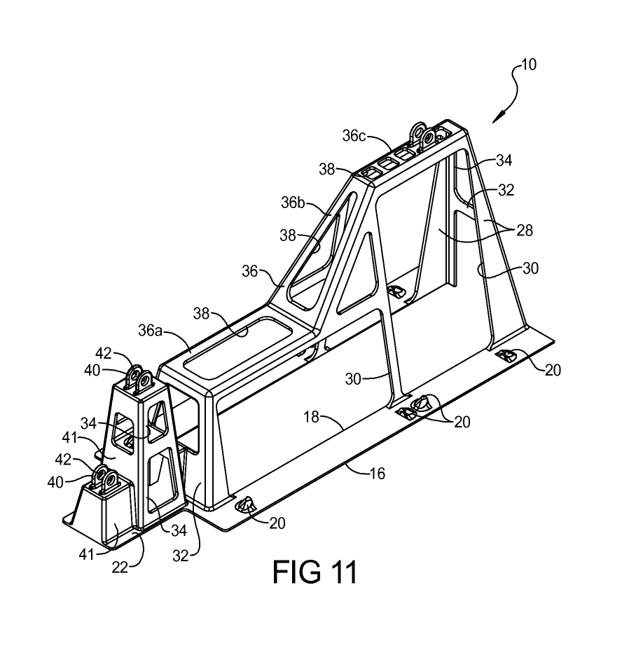

Referring to FIG. 11, still another embodiment, according to the present invention, of the plastic mounting support 10 is shown. Like parts of the plastic mounting support 10 have like reference numerals. In this embodiment, the plastic mounting support 10 includes the base 16 having a second projection 40 extending outwardly and upwardly from a second pedestal 41 extending upwardly from the mounting flange wall 22. The second pedestal 41 has a height greater that the first pedestal 41 resulting in the second projection 40 having a height greater than the first projection 40. The second projection 40 has an aperture 42 extending therethrough to receive a fastening mechanism such as a fastener or rod (not shown) for connection to the solar panel 12. The second projection 40 may a single piece or a pair of members spaced laterally from each other with each member having an aperture 42 extending therethrough. It should be appreciated that the plastic mounting support is similar to that illustrated in FIGS. 1 through 4.

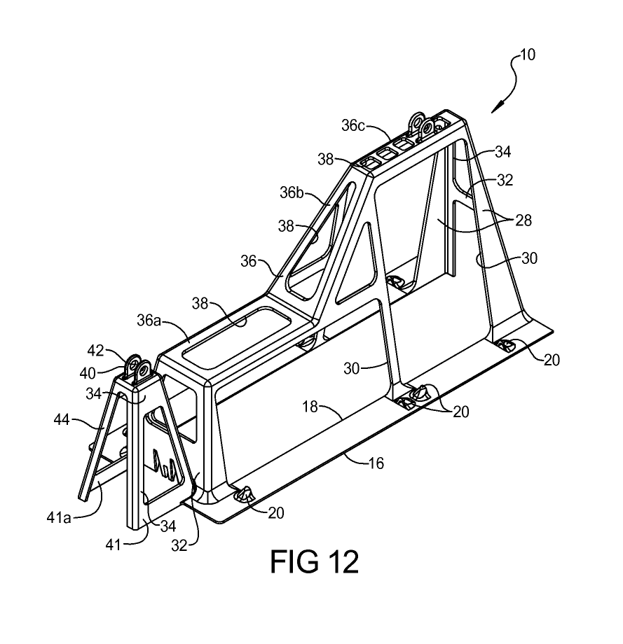

Referring to FIG. 12, a further embodiment, according to the present invention, of the plastic mounting support 10 is shown. Like parts of the plastic mounting support 10 have like reference numerals. In this embodiment, the plastic mounting support 10 includes the base 16 eliminating the first projection 40 and having the second projection 40 extending outwardly and upwardly from the second pedestal 41 extending upwardly from the mounting flange wall 22. The second pedestal 41 has an aperture 41a extending through a forward portion thereof. The second projection 40 has an aperture 42 extending therethrough to receive a fastening mechanism such as a fastener or rod (not shown) for connection to the solar panel 12. The second projection 40 may a single piece or a pair of members spaced laterally from each other with each member having an aperture 42 extending therethrough. It should be appreciated that the plastic mounting support 10 is similar to that illustrated in FIGS. 1 through 4. It should also be appreciated that the first pedestal 41 or second pedestal 41 of plastic mounting support 10 may be formed by using one mold with an insert tool in a local area thereof such that either only the first pedestal 41 of FIGS. 1 through 4 is formed or only the second pedestal 41 of FIG. 12 is formed for the height desired. It should further be appreciated that the insert tool may not be used such that both the first pedestal 41 and second pedestal 41 of FIG. 11 is formed for both heights desired.

Accordingly, the plastic mounting support 10, 110, 210 combines a plastic structure with one or more ballast blocks 26 such that the ballast blocks 26 carries part of the load on the support 10, 110, 210 or may carrier the load in case the plastic structure has any deformation due to creep, etc. The plastic mounting support 10, 110, 210 uses one or more ballast blocks 26 as support to resist upward loading against the solar panel 12 due to wind uplift and carries the downward loading against the solar panel 12 due to snow or seismic activity or any other type of loading. The plastic mounting support 10, 110, 210 in combination with one or more ballast blocks 26 reduces the amount of plastic material used for the support, resulting in significant cost savings. It should be appreciated that the plastic mounting support 10, 110, 210 could further reduce the amount of plastic material used such as by reducing the thickness of the material and/or using a shim (not shown) between the ballast blocks 26 and the plastic mounting support 10, 110, 210. It should further be appreciated that the ballast block 26 may be or not be a load carrying member.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

1. A plastic mounting support for a solar panel comprising:
a plastic base adapted to engage a support surface and support a ballast block; and
a plastic member for connection to the solar panel and cooperating with said base to hold the ballast block therebetween such that the ballast block cooperates with said plastic mounting support to carry part of a downward load on the solar panel, as well as, resists an upward wind load on the solar panel.

2. A plastic mounting support as set forth in claim 1 wherein said member includes at least one aperture extending therethrough.

3. A plastic mounting support as set forth in claim 1 wherein said member includes a pair of apertures spaced longitudinally and extending laterally therethrough and each aperture adapted to receive the ballast block.

4. A plastic mounting support as set forth in claim 3 wherein said base includes opposed stops adjacent each of said apertures adapted to hold the ballast block therein.

5. A plastic mounting support as set forth in claim 3 wherein one of said apertures has a height greater than a height of the other one of said apertures.

6. A plastic mounting support as set forth in claim 1 including a first projection extending upwardly from said base and having an aperture extending therethrough.

7. A plastic mounting support as set forth in claim 6 including a second projection extending upwardly from said base and having an aperture extending therethrough, said second projection having a height greater than said first projection.

8. A plastic mounting support as set forth in claim 1 including a projection extending upwardly from said member and having an aperture extending therethrough.

9. A plastic mounting support as set forth in claim 8 wherein said member includes a pair of side members extending from said base and over a side of the ballast block opposite the side contacting said base.

10. A plastic mounting support as set forth in claim 9 including a top member extending longitudinally between said side members.

11. A plastic mounting support as set forth claim 8 including at least one projection extending upwardly from said top member and having an aperture extending therethrough for attachment to the solar panel.

12. A plastic mounting support as set forth in claim 8 including an end wall extending generally perpendicular to said base.

13. A plastic mounting support as set forth claim 1 wherein said base and said member are integral, unitary, and one-piece.

14. A plastic mounting support as set forth in claim 1 wherein said base has opposed side wall, each of said side walls having an aperture extending therethrough.

15. A plastic mounting support as set forth in claim 14 including a plastic cap adapted to be disposed on the ballast block opposite said base.

16. A plastic mounting support as set forth in claim 15 wherein said cap has opposed side walls, each of said side walls having an aperture extending therethrough.

17. A plastic mounting support as set forth in claim 14 wherein said member comprises a pair of straps, one of said straps extending between one of said apertures of said base and one of said apertures of side walls.

18. A plastic mounting support as set forth in claim 15 wherein said cap includes a projection extending outwardly and having an aperture extending therethrough for attachment to the solar panel.

19. A plastic mounting support as set forth in claim 1 wherein said plastic mounting support is made from an injection molding process.

20. A plastic mounting support as set forth in claim 1 wherein said base and said member are made of a polymeric material that is a thermoplastic material or a thermoset material.

21. A mounting support for a solar panel comprising:
at least one ballast block;
a plastic base adapted to engage a support surface and support said at least one ballast block; and
a plastic member for connection to the solar panel and cooperating with said base to hold said at least one ballast block therebetween such that said at least one ballast block cooperates with said mounting support to carry part of a downward load on the solar panel, as well as, resists an upward wind load on the solar panel.
